(19) United States
(12) Patent Application Publication
(10) Pub. No.: US 2022/0161203 A1
(43) Pub. Date: May 26, 2022

(54) TUBULAR MEMBRANE COMPRISING LONGITUDINAL RIDGES, DEVICE PROVIDED THEREWITH AND METHOD FOR PRODUCING SUCH MEMBRANE

(71) Applicant: BERGHOF MEMBRANE TECHNOLOGY GMBH, Leeuwarden (NL)

(72) Inventors: Kimball Sebastiaan ROELOFS, Leeuwarden (NL); Gunther BISLE, Leeuwarden (NL); Piotr Edward DLUGOLECKI, Leeuwarden (NL)

(73) Assignee: BERGHOF MEMBRANE TECHNOLOGY GMBH, Leeuwarden (NL)

(21) Appl. No.: 17/602,346

(22) PCT Filed: Apr. 9, 2020
(86) PCT No.: PCT/NL2020/050243

§ 371 Date: Oct. 8, 2021

(30) Foreign Application Priority Data
Apr. 10, 2019 (NL) 2022918

(51) Int. Cl. B01D 69/04; B01D 69/02; B01D 63/06; B01D 67/00; B01D 69/10

(52) U.S. Cl. CPC B01D 69/046; B01D 69/02; B01D 63/061; B01D 2319/04; B01D 67/0013; B01D 69/10; B01D 2325/06; B01D 63/063

(57) ABSTRACT

A tubular membrane, a membrane module, a device including a number of such membranes, and a method for manufacturing such membranes. The tubular membrane includes a tubular base providing a support and having an inner and outer surface, where the tubular base defines a lumen for the feed flow, and a membrane layer provided on the inner surface of the tubular base, where the inner surface of the tubular membrane includes a number of inwardly projecting ridges that extend in a substantially longitudinal direction of the tubular membrane.

The present invention relates to a tubular membrane. Such tubular membranes are used in filtering a fluid, for example wastewater treatment (in bioreactors), reclamation of reusable materials, reverse osmosis concentrate treatment and concentration of feed streams.

Membranes and more specifically tubular polymeric membranes are known from practice and comprise a base from a porous support material. Such tubular base acts as a support tube and can be manufactured in different ways. For example, EP 0 684 068 A2, GB 1325673 A, and U.S. Pat. No. 4,214,612 disclose manufacturing methods for such tubular base, wherein an inner wall of the tubular base is provided with a membrane layer.

To minimize buildup of a fouling layer, turbulence enhancers are sometimes provided for mixing the boundary layer. WO 2015/108415 for example discloses providing at least one inwardly projecting helical ridge on the membrane inner wall with the helical ridge being covered with or forms part of the membrane layer. Although this reduces build-up of fouling, the occurrence of fouling along the membrane layer remains a problem. Periodically chemical cleaning of the membrane is required. However, if severe fouling or clogging of the membranes happens only chemical cleaning may not be sufficient. Therefore, occasionally mechanical cleaning may be needed to remove this severe fouling from the lumen side of the tubes and restore membrane performance. This type of cleaning may damage the turbulence enhancers thereby reducing the effects thereof. For example, (mechanical) cleaning may damage the turbulence enhancers, such as a helical ridge, during the cleaning operation. This leads to a performance decrease during the lifetime of the tubular membrane.

The invention is aimed at obviating or at least reducing the aforementioned problems and to provide an effective tubular membrane providing membrane surface enlargement and improve membrane effectivity.

This object is achieved with the tubular membrane according to the invention, the tubular membrane comprising:
a tubular base providing a support and having an inner and outer surface, wherein the tubular base defines a lumen for the feed flow;
a membrane layer that is provided on the inner surface of the tubular base,

wherein the inner surface of the tubular membrane comprises a number of inwardly projecting ridges that extend in a substantially longitudinal direction of the tubular membrane.

The tubular polymeric membrane according to the invention comprises a tubular base acting as a support layer that is shaped as a support tube. This tubular base can be provided by bending or winding tapes of porous material and sealing or welding these tapes together to obtain a tubular base that forms a lumen for the feed flow. This tubular base provides the (mechanical) stability of the tubular membrane. For example, for ultrafiltration membranes the tubular base involves a double-layer nonwoven support.

The tubular base has an inner and outer surface. The inner surface is provided with membrane material to provide a membrane layer on this inner surface of the tubular base. This membrane layer can be provided on the inner surface in different ways. For example, a liquid polymer (dope) solution is cast onto the inner surface of the tube followed by a doctoring process. During casting and doctoring the polymer solution may partially intrude the tubular base layer.

The tubular membrane according to the invention comprises a number of inwardly projecting ridges that are provided on the inner surface of the tubular membrane with the inwardly projecting ridges extending in a substantially longitudinal direction of the tubular membrane. In this respect it is noted that extending in a substantially longitudinal direction of the tubular membrane is understood by the skilled person as extending in a substantially straight line parallel to a longitudinal axis of the membrane. This tubular membrane according to the invention is also called a longitudinally-ridged membrane.

In a presently preferred embodiment of the invention the ridges are substantially formed from membrane material. Furthermore, the shaping of the longitudinal ridges is preferably achieved in the doctoring section after the providing of membrane material to the inner surface of the tubular base. This shaping of the ridges involves a manufacturing process that can be manufactured relatively easy on an industrial scale in an economic feasible manner, thereby enabling the providing of a cost-effective tubular membrane having a larger membrane surface area.

Providing longitudinal ridges increases the overall effective membrane surface area. This increases the overall capacity of the tubular membrane, thereby increasing the overall capacity of a tubular membrane module resulting in higher module fluxes.

A further advantage and effect that is achieved by providing the tubular membrane with longitudinal ridges is that the surface turbulence is increased. This increased surface turbulence may be caused by higher stirring due to the ridges and/or by speed differences between the center of the tube and the area between adjacent ridges close to the inner surface of the tubular base. This increased turbulence achieves a higher flux because of fouling reduction.

Furthermore, cleaning, such as mechanical cleaning, can be performed relatively straight forward in the tubular membrane having longitudinal ridges according to the invention. The risk of damaging the longitudinal ridges is kept to a minimum, such that performance of the membrane modules can be recovered and further applied after cleaning ensuring a longer lifetime of the tubular membrane module. In other words, in case of severe fouling, membranes having longitudinal ridges are more resistant to mechanical cleaning and they can be (mechanically) cleaned such that the performance of the membranes can be recovered. The improved resistance to mechanical cleaning (i.e. less damage during mechanical cleaning) is mainly due to the fact that the ridges extend in a substantially straight line along the length of the membrane. By providing longitudinal (i.e. straight) ridges that are parallel to the membrane longitudinal axis, the mechanical cleaning means exert a continuous force to the membrane surface, which results in a lower stress on the membrane wall and, thus, in less damage to the membrane wall.

In addition, the tubular membrane with longitudinal ridges has a smaller pressure drop over the module, thereby achieving lower operational costs for a membrane module.

In a presently preferred embodiment of the invention the inner surface of the tubular membrane comprises more than one inwardly projecting longitudinal extending ridge,

By providing more than one inwardly projecting longitudinal extending ridge the membrane surface area is further increased and local turbulence is improved to reduce fouling. This further enhances the performance of the tubular membrane.

Preferably, the inner surface of the tubular membrane comprises more than 4 ridges, preferably more than 6 ridges, and most preferably comprises a number of ridges in the range of 7-12. Experiments showed that a number of ridges in the range of 4-12 further improved the overall performance while maintaining a (substantially) constant pressure drop of the tubular membrane.

In a further preferred embodiment of the invention the ridges comprise a cross section that is perpendicular to the average feed flow direction through the lumen, wherein the cross section of the ridges has a non-circular shape.

By providing a non-circular shape for the ridges the effective membrane surface area is further increased. Furthermore, the non-circular shape enables the providing of additional support such that the ridges are robust and thoroughly connected to the tubular base. This is especially true in case the shape resembles an ellipse, more specifically half thereof.

In a presently preferred embodiment of the invention the ridge or ridges have an average height in the range of 50-2000 μm, preferably in the range of 100-500 μm, more preferably in the range of 15-400 μm, and is most preferably in the range of 200-350 μm.

Preferably, the ridge or ridges have a width in the range of 0.1-10 mm, preferably in the range of 0.5-5 mm, more preferably in the range of 1-4 mm, and most preferably in the range of 1.5-3 mm. It will be understood that the aforementioned width is associated with the average width, and that deviations between ridges may occur with occasionally a width falling outside the desired range.

These ranges for the average height and width of the ridge or ridges are presently preferred for tubular membranes having a (internal) diameter of about 8 mm. It will be understood that other tubular membranes according to the present invention may also have other (internal) diameters, for example in the range of 5-14 mm having a circumference in the range of about 15.7-44.0 mm. Alternatively, the ridge height is related to the membrane inner diameter such that the ridge height is in the range of 0.4-40% of the membrane inner diameter, and preferably 1-10% of the membrane inner diameter, more preferably in the range of 1.5 8% of the membrane inner diameter, and most preferably in the range of 2-7% of the membrane inner diameter. Similarly, the ridge width is related to the membrane inner circumference such that the width is in the range of 0.2-63.7% of the membrane inner circumference, preferably in the range of 1.6-31.8% of the membrane inner circumference, more preferably in the range of 3.2-25.5% of the membrane inner circumference and most preferably in the range of 4.8-19.1% of the membrane inner circumference.

It will be understood that the height and the width relate to the average height and average width in case of more than one ridge in the tubular membrane. Experiments showed effective ridges with these dimensions in a commercially available tubular membrane geometry.

The invention thither also relates to a membrane module and a (filtering) device for filtering a fluid, the membrane module and device comprising a number of tubular membranes in an embodiment according to the present invention.

The membrane module and/or device provide the same or similar effects and advantages as described in relation to the tubular membrane. These modules and/or devices can be used in different operations, for example wastewater treatment (in bioreactors), reclamation of reusable materials, reverse osmosis concentrate treatment and concentration of feed streams.

The use of the tubular membranes in the filtering device according to the invention, such as a water treatment device, improves the overall capacity and reduces fouling such that the performance of the tubular membranes is improved and/or remains substantially constant over its lifetime as compared to conventional membranes.

The present invention further also relates to a method for producing a tubular membrane according to an embodiment of the present invention, with the method comprising the steps of:
providing a tubular base;
providing a membrane structuring tool configured for providing the membrane layer material to the inner surface of the tubular base,

wherein the structuring tool is configured to provide a number of inwardly projecting ridges on the inner surface of the tubular base that extend in a substantially longitudinal direction of the tubular membrane.

The method provides the same or similar effects and advantages as described in relation to the tubular membrane and/or device.

The method comprises the step of providing a tubular base. Such tubular base can be provided by helically winding of one or more porous material tapes where the overlapping edges are sealed together to provide the tubular base structure, for example. A membrane structuring tool is provided to enable the providing of membrane layer material to the inner surface of the tubular base. According to the invention, the membrane structuring tool is configured to provide a number of inwardly projecting ridges on the inner surface of the tubular member that extend in a substantially longitudinal direction of the tubular membrane. This is preferably done in the casting section wherein the polymer dope leaves the mandrel and enters above the doctoring section. The membrane structuring tool preferably forms a defined layer from polymer dope on the inside lumen of the tubular base. This structuring tool can be provided in different embodiments and/or ways. For example, the structuring tool may comprise a number of longitudinal grooves such that the membrane material is shaped by these grooves and is provided on the inner surface as longitudinal extending ridges thereon. Alternatively, the structuring tool comprises a number of longitudinal or helical grooves and the structuring tool rotates such that the membrane material is provided on the inner surface of the tubular base providing ridges that extend in a substantially longitudinal direction. For example, this involves rotating the structuring tool with the same rotating velocity as the tubular base layer. This involves effective control of the tool rotation and preferably the winding speed when forming the tubular base. This can be achieved by providing a dedicated speed control and/or providing a connection between the structuring tool and the winding of tubular base such that the ridges are provided in a longitudinal direction forming the tubular membrane. This can be achieved by friction or clamping of the structuring tool relative to the tubular base, for example. Additionally, between the ridges sufficient thickness of polymer membrane layer should be applied to keep membrane performance constant and to prevent pinholes or other defects in the thin part of the membrane layer.

Further advantages, features and details of the invention are elucidated on the bases of preferred embodiments thereof, wherein reference is made to the accompanying drawings, in which:

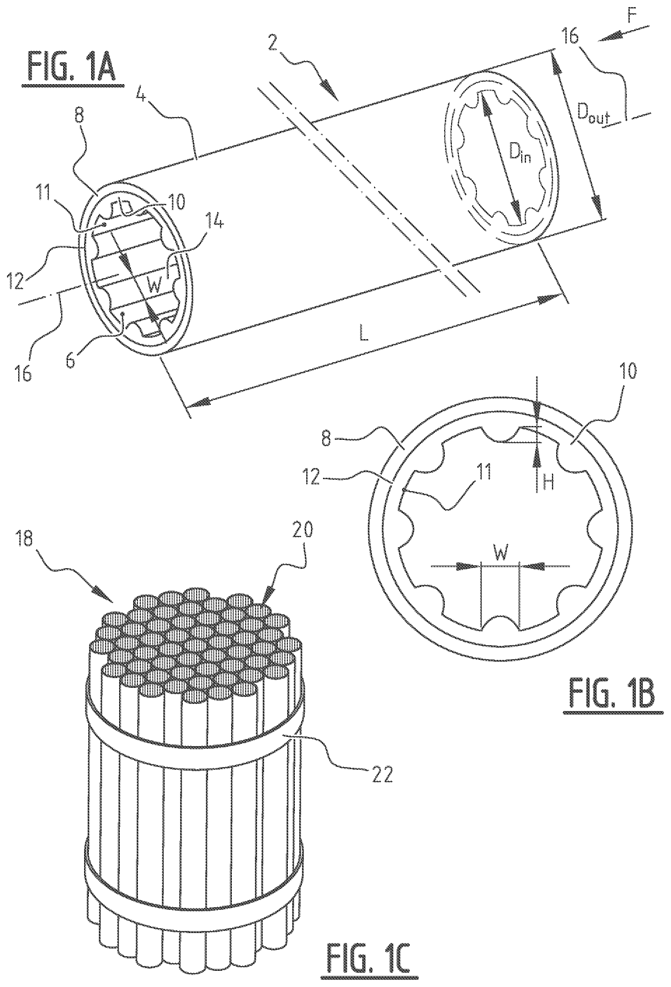

FIG. 1A schematically shows a tubular membrane of the embodiment of the invention;

FIG. 1B shows a cross section of the tubular membrane of FIG. 1a;

FIG. 1C schematically shows a device with a number of tubular membranes of FIG. 1A;

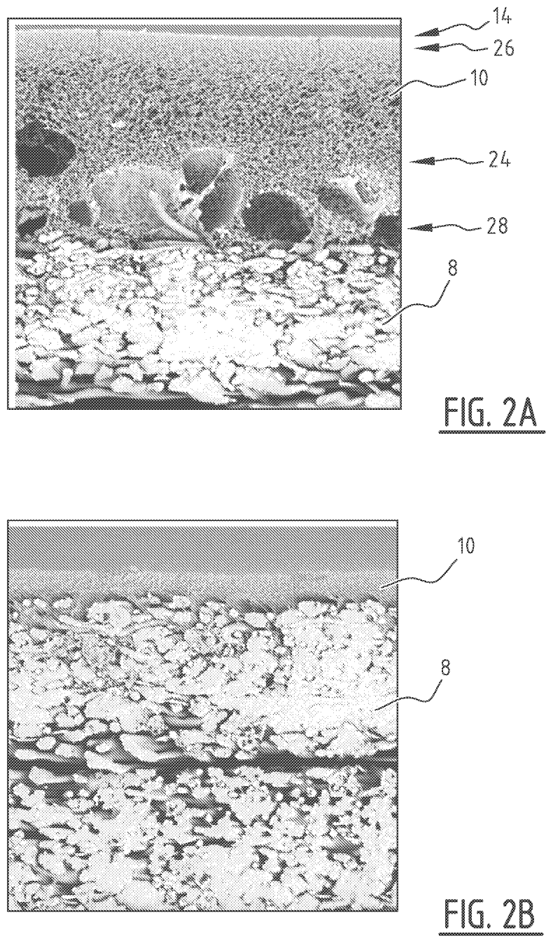

FIG. 2A shows a detailed cross section of the ridge of the tubular membrane of FIG. 1A;

FIG. 2B shows a detailed cross section of the surface area between two ridges in the tubular member of FIG. 1A; and

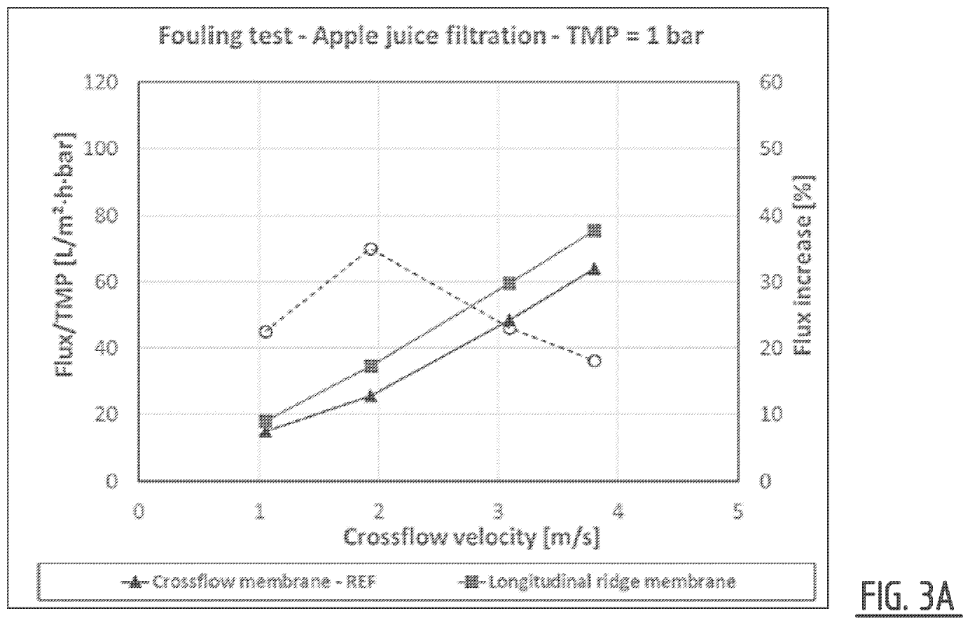

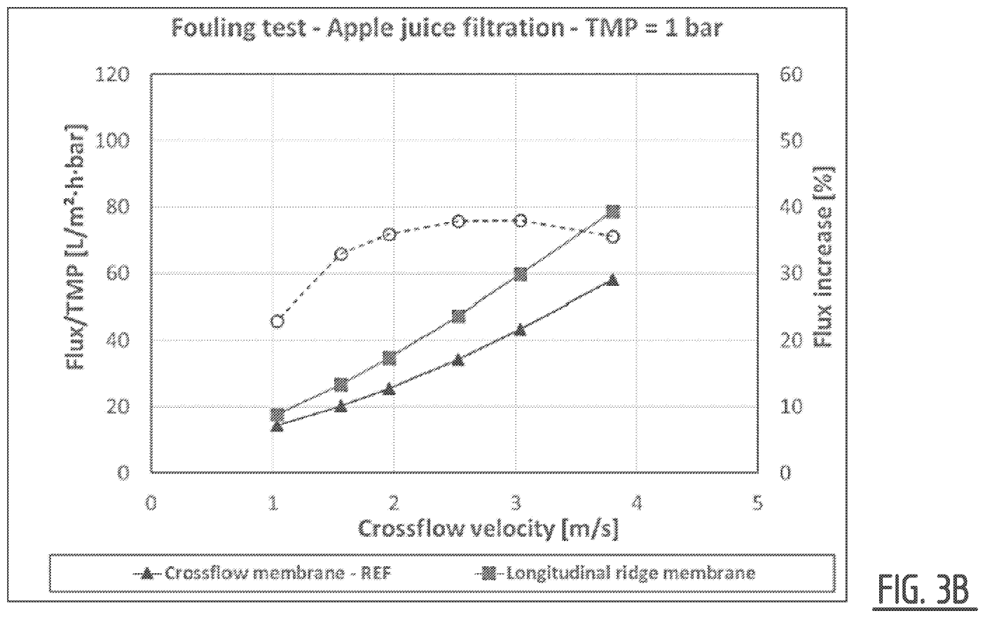

FIG. 3A-B shows experimental results with a tubular membrane according to the invention.

Tubular membrane 2 (FIG. 1A) has a length L, an inner diameter Dᵢₙ, and an outer diameter Dₒᵤₜ. Furthermore, tubular membrane 2 has outer wall 4 and inner wall 6. Outer wall 4 is defined by outer layer 8 that in the illustrated embodiment comprises a non-woven material. The non-woven material optionally comprises PET, PBT, PP, PE, PA, PAN or combinations thereof. The tubular member cross section is substantially circular shaped, although other shapes such as oval or ellipse shapes can be envisaged. It will be understood that other dimensions for tubular membrane 2 and/or its parts can also be envisaged in accordance with the present invention.

Inner wall 6 comprises polymer membrane material 10. The polymer membrane material preferably comprises one or more of polyethersulfone (PES), polysulfone (PSf), polyphenylsulfone (PPSU), polyvinylidene fluoride (PVDF), polyamide (PA), polyacrylonitrile (PAN), polyethylene (PE), polypropylene (PP) and combinations thereof. Part of the tubular base is intruded with polymer membrane material defining a transition region 12.

The inner wall 6 of tubular membrane 2 comprises a number of longitudinal ridges 14. In the illustrated embodiment tubular membrane 2 comprises eight ridges 14 that extend substantially parallel two central axes 16 of tubular membrane 2.

Ridge 14 (FIG. 1B) has height H and width W. In the illustrated embodiment height H is in the range of 200-350 μm and width W is in the range of 1.5-4 mm. Preferably all ridges have a height H and width W within this range.

Device 18 (FIG. 1C) comprises a bundle 20 of tubular membranes 2 in a holder or housing 22. This enables feed flow to enter the lumen side of bundle 20. On the shell side the permeate is collected and is conducted from the system through permeate ports. It will be understood that the skilled person could envisage different embodiments of device 18 comprising a number of tubular membranes 2.

Ridge 14 (FIG. 2A) has asymmetric pore structure 24 with a small surface pores on the lumen side 26 that is positioned towards the center of tubular membrane 2 as seen in a cross section, and a large pores area 28 that is close to and/or attached to tubular base 8. In the illustrated embodiment the total (average) height H of ridge 14 is in the range of 250-350 μm. The membrane surface area between adjacent ridges 14 has a height that is much smaller (FIG. 2B). In fact, the thickness of this membrane material layer is about 40-60 μm.

Tubular membrane 2 is provided by providing tubular base 8. In the illustrated embodiment tubular base 8 is provided by helically winding porous material, preferably a non-woven material, and sealing or welding the overlap between adjacent strips together. In a next step, membrane material is cast and doctored onto the inner surface using a structuring tool that is provided with grooves such that ridges 14 are formed.

Tests have been performed with tubular membrane 2. In the tests an unfiltered apple juice fluid is used to determine the effect of fouling. Tubular membrane 2 is compared to conventional membranes without ridges. Tests have been performed at a TMP of 1 bar, with tubular membrane 2 having eight ridges, The flux is defined as the permeate volume collected in a defined time interval through a defined surface area of membrane. Flux/TMP is determined in L/m²/h/bar at cross flow velocity ranging from 1-4 m/s. Results with a first membrane are shown in FIG. 3A and results with a second membrane are shown in FIG. 3B. The tubular membrane with longitudinal ridges shows results (▪) that are substantially higher as compared to the reference membrane (▴). This achieves a significant flux increase (∘, in %). This flux increase is achieved by enlargement of the effective membrane surface area and by the increased turbulence by the ridges acting as turbulence enhancers. These combined effects are synergetic and are surprisingly higher as would be expected from the membrane surface enlargement. Therefore, the performance of tubular membrane 2 according to the invention is even better as would be expected, thereby improving the possibilities for its industrial application. These possibilities are even further enhanced by the improved cleaning possibilities.

### EXAMPLE 1

### Experimental Results

The tubular membranes according to the invention have been tested in a leachate treatment MBR plant at a landfill. The purpose of the test was to compare the tubular membranes according to the invention with reference membranes, which in this are tubular flow membranes that do not have ridges (i.e. having a flat membrane wall). For the purpose the test, the membranes according to the invention have been labelled as Longitudinally-ridged membranes, whereas the reference membranes having a flat membrane wall have, been labelled as Reference membranes.

The design inflow to the test plant is 1.8 minimal liquid discharge (MLD), though it has actually been treating peak loads of 2.2 minimal liquid discharge (MLD). The process is a classical BIOMEMBRAT® with a pressurised bioreactor tank operating at a hydraulic retention time (HRT) of 15 hours, a solid retention time (SRT) of 53 days and an aeration rate of 4000 Nm³/h. Following flow balancing, the leachate is treated in two parallel lines, each consisting of a denitrification and two nitrification tanks. The sludge from each line is pumped into two ultrafiltration (UF) plants comprising three streams of 6 modules in series, the permeate being directly discharged.

Modules with the longitudinally-ridged and reference membranes were prepared. In order to provide similar test conditions, the longitudinally-ridged membranes and the reference membranes were placed in two different parallel loops, which are fed from the same bioreactor to provide similar test conditions.

Each module was a type 83G module having a 20.32 cm (8″) diameter and a module length of 3 meter, Each membrane in the module was 8 mm in diameter, which led to a total membrane area of 27.2 m² in each module.

During testing, the following test parameters were applied:
Filtration type; continuous, feed and bleed, bottom to top;
Crossflow velocity (CFV): 4 m/s;
Transmembrane pressure (TMP): 2.0-2.2 bar;
Temperature 25-30° C.;
Feed mixed liquor suspended solids (MLSS): 21-23 g/L;
Inlet chemical oxygen demand (COD): 1500-2300 mg/L.

The test results shows that the COD-removal of the tubular membranes according to the invention achieved 85%-87%, whereas the total suspended solids (TSS) was below 75 mg/l. Moreover, the tubular membranes according to the invention, due to the straight longitudinally extending ridges, achieved a significantly higher flow rate than the reference membranes with no ridges. This is also shown in graph 1 provided below.

The present invention is by no means limited to the above described preferred embodiments thereof. The rights sought are described in the following claims, wherein the scope of which many modifications can be envisaged.

1. A tubular membrane comprising:
a tubular base providing a support and having an inner and outer surface, wherein the tubular base defines a lumen for the feed flow; and
a membrane layer that is provided on the inner surface of the tubular base, wherein the inner surface of the tubular membrane comprises a number of inwardly projecting ridges that extend in a substantially longitudinal direction of the tubular membrane.

2. The tubular membrane according to claim 1, wherein the ridges comprise membrane material.

3. The tubular membrane according to claim 1, wherein the inner surface of the tubular membrane comprises more than one inwardly projecting longitudinal extending ridge.

4. The tubular membrane according to claim 3, wherein the inner surface of the tubular membrane comprises more than 4 said ridges.

5. The tubular membrane according to claim 1, wherein the ridges comprise a cross section that is perpendicular to the average feed flow direction through the lumen, wherein the cross section has a non-circular shape, such as an ellipse.

6. The tubular membrane according to claim 1, wherein the ridge or ridges have an average height in the range of 50-2000 μm.

7. The tubular membrane according to claim 1, wherein the ridge or ridges have a width in the range of 0.1-10 mm.

8. The tubular membrane according to claim 1, wherein a ridge height of the ridge or ridges is related to the membrane inner diameter such that the ridge height is in the range of 0.4-40% of the membrane inner diameter.

9. The tubular membrane according to claim 1, wherein a ridge width of the ridge or ridges is related to the membrane inner circumference such that the ridge width is in the range of 0.2-63.7% of the membrane inner circumference.

10. A membrane module comprising a number of the tubular membranes according to claim 1.

11. A device for filtering a fluid, the device comprising a number of the membrane modules and/or tubular membranes according to claim 1.

12. A method for producing a the tubular membrane according to claim 1, comprising :
providing a tubular base; and
providing a membrane structuring tool configured for providing the membrane layer material to the inner surface of the tubular base,
wherein the structuring tool is configured to provide a number of inwardly projecting ridges on the inner surface of the tubular base that extend in a substantially longitudinal direction of the tubular membrane.

13. The method according to claim 12, further comprising the step of moving the structuring tool such that the ridges are provided on the inner surface.

14. The method according to claim 12, wherein the structuring tool comprises a number of grooves configured for providing membrane material to the inner surface.
